(19) United States
(12) Patent Application Publication
(10) Pub. No.: US 2026/0119828 A1
(43) Pub. Date: Apr. 30, 2026

(54) SYSTEM AND METHOD FOR PRESENTING DIGITAL EMULATED CARDS

(71) Applicant: STMicroelectronics (China) Investment Co., Ltd, Shanghai (CN)

(72) Inventor: Sebastien Andre Frederic DECUGIS, Seoul (KR)

(73) Assignee: STMicroelectronics (China) Investment Co., Ltd, Shanghai (CN)

(21) Appl. No.: 19/116,930

(22) PCT Filed: Oct. 8, 2022
(86) PCT No.: PCT/CN2022/123756

§ 371 Date: Mar. 28, 2025

(51) Int. Cl. G06K 7/10

(52) U.S. Cl. CPC G06K 7/10297

(57) ABSTRACT

A near field communication (NFC) device stores a plurality of digital emulated cards. When the NFC device detects the carrier field from an NFC reader, the NFC device enters a silent monitoring phase in which the NFC device records characteristics of a plurality of polling cycles of the NFC reader without responding to the NFC reader. The NFC device selects a digital emulated card based on the characteristics of the polling cycles. The NFC device presents the selected digital emulated card to the NFC reader.

### BACKGROUND

### Technical Field

The present disclosure relates to the field of near field communication (NFC). The present disclosure relates more particularly to selecting digital emulated cards for NFC communication.

### Description of the Related Art

NFC technology utilizes radiofrequency signals to enable devices to communicate with each other in close proximity. Many applications of NFC technology utilize an NFC reader to interrogate and receive data from an NFC device. The NFC reader typically outputs an interrogation signal. If an NFC device is within range of the interrogation signal, then the NFC device responds by providing an identification signal identifying the NFC device. After the NFC device has identified itself, the NFC reader and the NFC device can further exchange information.

One type of NFC device is a mobile phone with NFC capabilities. The mobile phone can store digital emulated card data for a plurality of NFC cards. One may indifferently refer to digital emulated card or emulated cards hereinafter. The emulated cards can include emulated access cards that grant access to a building, a room, or other types of locations. The emulated cards can include emulated transit cards that grant access to transit services such as municipal trains, busses, or other types of transit services. The emulated cards can include emulated banking cards corresponding to debit cards, credit cards, or other types of financial transaction cards. In these cases, a user does not carry physical NFC cards, but rather the mobile phone stores data related to one or more NFC cards. When a user approaches an access point, the user can present the mobile phone to the NFC reader. The mobile phone communicates with the NFC reader and presents the digital emulated card data to the NFC reader.

In some cases, a mobile phone, or other type of NFC device, may store digital emulated card data for a large number of emulated cards. In these cases, it can be cumbersome to present the correct digital emulated card data from the mobile phone to an NFC reader at an access point.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide an NFC device that is able to efficiently select a correct digital emulated card from a plurality of digital emulated cards card to present to an NFC reader. When the NFC device detects a signal from an NFC reader, the NFC device listens to the signal without responding. The NFC device analyzes characteristics of the signal in order to determine the type of the NFC reader. The NFC device then selects a digital emulated card based on the type of the NFC reader. After selecting a digital emulated card, the NFC device responds to the NFC reader and presents the selected digital emulated card data.

In one embodiment, an NFC reader outputs a carrier field. The NFC reader may periodically embed an interrogation signal within the carrier field. When the user approaches an access point that includes an NFC reader for granting access, the user may position an NFC device in proximity to the NFC reader. The NFC device receives the carrier field and the interrogation signal. The NFC device does not respond to the interrogation signal. Instead, the NFC device records characteristics of either or both of the carrier field and the interrogation signal for several cycles of the interrogation signal or for a selected amount of time. The NFC device then selects a digital emulated card based on the characteristics of the carrier field and the interrogation signal.

In one embodiment, the NFC device includes profile data associated with various types of NFC readers. When the NFC device analyzes characteristics of a newly received carrier field, the NFC device can match the profile data stemmed from the characteristics of the newly received carrier field to some data of a profile associated with a particular type of NFC reader (e.g. a specific manufacturer or model). The NFC device can then select a digital emulated card based on the matched NFC reader type.

In one embodiment, a method includes receiving, with an NFC device, a plurality of first polling cycles from an NFC reader without responding to the NFC reader and analyzing, with the NFC device, characteristics of the first polling cycles. The method includes selecting, with the NFC device, a digital emulated card from a plurality of digital emulated cards based on the characteristics of the first polling cycles and presenting the selected digital emulated card to the NFC reader from the NFC device via NFC communication.

In one embodiment, a method includes storing a plurality of digital emulated cards in an NFC device, storing, in the NFC device, profile data associated with a plurality of types of NFC readers, and receiving, with the NFC device, a plurality of first polling cycles from an NFC reader without responding to the NFC reader. The method includes matching the NFC reader to one of the types of NFC readers in the profile data based on characteristics of the first polling cycles, selecting one of the digital emulated cards from the plurality of digital emulated cards based on the matching, and presenting the selected digital emulated card to the NFC reader from the NFC device via NFC communication.

In one embodiment, an NFC device includes an NFC antenna and a memory configured to store digital emulated card data of a plurality of digital emulated cards the NFC device includes a controller coupled to the memory and the NFC antenna and configured to implement a silent monitoring phase responsive to the NFC antenna receiving a carrier field from an NFC reader.

In one embodiment, a method includes storing a plurality of digital emulated cards in an NFC device, storing, in the NFC device, profile data associated with a plurality of types of NFC readers, and receiving, with the NFC device, a plurality of first polling cycles from an NFC reader without responding to the NFC reader. The method includes recording, with the NFC device, characteristics of the first polling cycles, receiving a second polling cycle from the NFC reader, and presenting, from the plurality of digital emulated cards, a default digital emulated card to the NFC device after receiving the second polling cycle.

### BRIEF DESCRIPTION OF THE SEVERAL VIEWS OF THE DRAWINGS

FIG. 1 is a block diagram of an NFC system, according to one embodiment.

FIG. 2 is a block diagram of an NFC device, according to one embodiment.

FIG. 3 illustrates timing diagrams of NFC signals, according to one embodiment.

FIG. 4 is a block diagram of an NFC reader profile, according to one embodiment.

FIG. 5 is a graph illustrating signals associated with NFC communication, according to one embodiment.

FIG. 6 is a flow diagram of a process for operating an NFC system, according to one embodiment.

FIG. 7 is a flow diagram of a process for operating an NFC system, according to one embodiment.

FIG. 8 is an illustration of an NFC system, according to one embodiment.

FIG. 9 is an illustration of an NFC system, according to one embodiment.

FIG. 10 is a flow diagram of a process for operating an NFC system, according to one embodiment.

FIG. 11 is a flow diagram of a process for operating an NFC system, according to one embodiment.

FIG. 12 is a flow diagram of a process for operating an NFC system, according to one embodiment.

### DETAILED DESCRIPTION

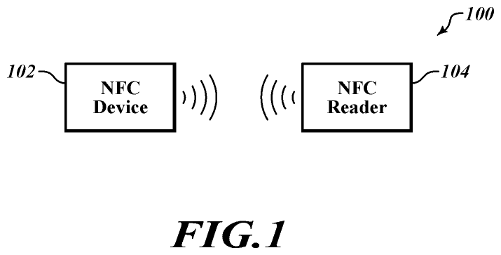

FIG. 1 is a block diagram of an NFC system 100, according to one embodiment. The NFC system 100 includes an NFC device 102 and an NFC reader 104. The NFC device 102 and the NFC reader 104 communicate with each other utilizing NFC technology.

In one embodiment, the NFC reader 104 grants access to a location or service. For example, the NFC reader 104 may control access to enter a building or to enter an area within a building. The NFC reader 104 may be communicatively coupled to a locking mechanism on the door. The NFC reader 104 may be configured to establish communication with an NFC device 102, to receive digital emulated card data from the NFC device 102, and to cause the locking mechanism to unlock the door or to otherwise open the door if valid digital emulated card data is presented. This can enable a user of the NFC device 102 to enter a building or room within a building.

In one embodiment, the NFC reader 104 may control access to a transportation service. For example, the NFC reader 104 may be positioned at an entry to a train, bus, or other transportation service at a particular region. The NFC reader may be configured to establish NFC communication with an NFC device, to receive digital emulated card data from the NFC device 102, and to grant access to the transportation service if the NFC device 102 presents valid emulated card data.

In one embodiment, the NFC reader 104 may control payment transactions for goods or services. For example, the NFC reader 104 may be positioned at a payment location of a store or other location that may process payment for goods or services. The NFC reader may be configured to establish NFC communication with an NFC device, to receive digital emulated card data from the NFC device 102, and to process payment for goods or services if the NFC device 102 presents valid emulated card data. In these cases, the emulated card data may correspond to a debit card, a credit card, a rewards card, or other type of financial transaction card. Accordingly, in one embodiment the NFC device 102 may store emulated card data for ticketing, payment, access control, or other types of actions. The emulated card data can include emulated cards for any service or secure area such as homes, automobiles, hotels, workplaces, etc.

An NFC device 102 may store digital emulated card data for a large number of emulated cards for a user. For example, the NFC device 102 may store digital emulated card data for a user's apartment building, a user's employment building, a hotel room, a train service in a first region, a train service in a second region, a bus service in a first region, a bus service the second region, and for various other locations or services. Each time the NFC device 102 is presented to an NFC reader 104, the user will not be granted access until the proper digital emulated card data is presented. As used herein, the terms “proper digital emulated card data” and “correct digital emulated card data” for an NFC reader can correspond to the emulated card associated with the NFC reader and configured to authorize an action (such as granting access, transacting payment, etc.).

One possible solution for the NFC device 102 is to sequentially present digital emulated cards to an NFC reader 104 until the correct digital emulated card is presented and access is granted. One drawback of this solution is that a large amount of time may be consumed before the correct digital emulated card is presented. For example, if a user stores in the NFC device 102 six different digital emulated cards for various locations and/or services, then in a worst-case scenario the NFC device 102 may only present the correct digital emulated card after presenting the five incorrect digital emulated cards. This may be very frustrating to the user and may lead to a poor user experience.

Another factor that may also increase the amount of time that elapses before a correct card is presented is that once the NFC device 102 presents data to the NFC reader 104, the behavior of the NFC reader 104 changes from a polling or interrogation mode to a communication mode. A relatively large amount of time may elapse before the NFC reader 104 reverts to a polling mode to enable the NFC device 102 to present the next emulated card. As used herein, “polling mode” can include an operational mode of an NFC reader prior to establishing communication with an NFC device. In the polling mode, the NFC reader checks continuously or during a predetermined period whether an emulated card (physical or emulated) is within the vicinity of the NFC reader.

An NFC device 102 in accordance with principles of the present disclosure avoids the drawbacks of other solutions by intelligently selecting a digital emulated card to be presented to an NFC reader 104 based on characteristics of the one or several signals output by the NFC reader 104. When a signal from an NFC reader 104 is detected by the NFC device 102, the NFC device 102 does not immediately respond to the signal. Instead, the NFC device 102 records characteristics of the signal. The NFC device 102 then analyzes the characteristics of the signal and identifies a type of the NFC reader 104 based on the characteristics of the signal. The NFC device 102 then selects a digital emulated card based on the type of the NFC reader 104. The NFC device 102 then presents the digital emulated card. In this way, the number of emulated cards presented by the NFC device 102 to the NFC reader is reduced. This results in a reduction in the length of time before the NFC device presents the emulated card associated with the NFC reader 104.

Further details regarding types of NFC readers 104 and characteristics of signals provided by NFC readers 104 will be provided below.

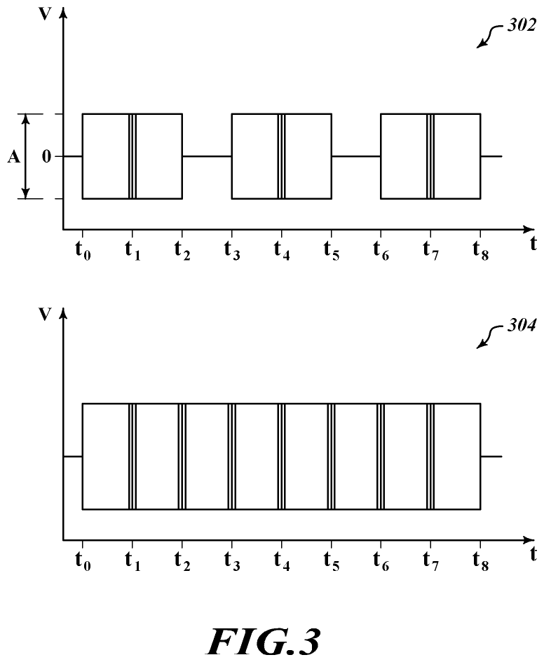

In one embodiment, the NFC reader 104 operates in a polling mode by default until NFC communication is established with an NFC device 102. During the polling mode, the NFC reader 104 outputs a carrier field. The carrier field is a radiofrequency signal that facilitates NFC communication. The NFC reader 104 periodically outputs an interrogation signal by modulating the carrier field. The interrogation signal is configured to induce a response from an NFC device 102 that is in communication range with the NFC reader 104. If the NFC device 102 is within range of the NFC reader 104, then the NFC device 102 can respond to the interrogation signal. Some examples of polling modes including carrier fields and interrogation signals are shown and described in relation to FIG. 3.

Some types of NFC readers 104 may output a carrier field without interruption during the polling mode. An NFC reader 104 may periodically embed an interrogation signal in the carrier field by modulating the carrier field. An NFC reader 104 may embed the interrogation signal in the carrier field at fixed timing intervals between interrogation signals. An NFC reader 104 may embed the interrogation signal and the carrier field with variable timing intervals between interrogation signals. An NFC reader 104 may utilize interrogation signals of a particular duration, particular amplitude, or a particular classification. One example of such a carrier field and interrogation signal is shown in relation to graph 304 of FIG. 3 in which the carrier field is on without interruption between times T0 and T8, with interrogation signals being embedded at times T1-T7.

Some types of NFC readers 104 may output a carrier field that turns on and off during the polling mode. For example, an NFC reader may output the carrier field for a selected duration of time and then may turn off the carrier field for a selected duration of time. The NFC reader 104 may output an interrogation signal after a particular amount of time has elapsed since the carrier field is turned on. The NFC reader 104 may turn the carrier field off for a selected duration of time. These various timings may be fixed or variable depending on the type of the NFC reader 104. One example of such a carrier field and interrogation signal is shown in relation to graph 302 of FIG. 3. The carrier field turns off between times T2 and T3 and between times T5 and T6. The interrogation signals occur at times T1, T4, and T7.

Some common NFC protocols define a standard frequency of 13.56 MHz for the carrier field, though other standard frequencies are possible depending on NFC protocols or future updates to NFC protocols. In spite of the standard frequency of 13.56 MHz for the carrier field, some types of NFC readers 104 may utilize oscillators that do not output the carrier field at the proper central frequency. Accordingly, the type of an NFC reader 104 may be recognized, in part, based on how far from the standard frequency the carrier field deviates.

Some types of NFC readers 104 output the carrier field with a higher amplitude than others. Accordingly, the amplitude of the carrier field can be an identifier of the type of the NFC reader 104, though the variable distance between the NFC device 102 and the NFC reader 104 should be taken into account when determining whether the measured amplitude of the carrier field is indicative of a type of the NFC reader 104.

The characteristics of the signals output by the NFC reader 104 are based, in part, on the manufacture and model of the NFC reader 104. Because the polling signal does not typically include data that expressly identifies a model or manufacture, the NFC device 102 can analyze the characteristics of the polling mode to identify a type of the NFC reader 104. Accordingly, the NFC device 102 may analyze the features of all the types of signals output by the NFC reader 104 during the polling mode in order to stem information relating to the type of the NFC reader.

The type of the NFC reader 104 can be useful in determining which emulated card to present to the NFC reader 104. For example, the train system in a particular region may utilize a specific type of NFC reader 104. The train system in another region may utilize another type of NFC reader 104. The bus system in a particular region may use a particular type of NFC reader 104. Buildings and other facilities may use particular types of NFC readers 104. NFC readers for ticketing, car access, financial transactions, and other types of actions or services may utilize particular types of NFC readers 104.

The NFC device 102 can store data, related to various types of NFC readers 104. In particular, the NFC device 102 can store profile data that includes profiles for various types of NFC readers 104. Each profile can include the characteristics of the signals provided by the type of NFC reader during polling. These characteristics can include one or a combination of the following characteristics: whether the carrier field is always on, whether the carrier field periodically turns off and then turns back on, the timing of the turning off and on the carrier field, the timing of the interrogation signals embedded in the carrier field, the type of interrogation signals, the amplitude of the carrier field, the frequency of the carrier field, or other types of information related to the signals provided during polling. Each profile can also indicate the locations and types of applications in which the NFC reader 104 is typically utilized, e.g. whether the type is associated with various types of access points in particular regions.

As set forth above, the NFC device 102 can store a large number of digital emulated cards. The NFC device 102 can store information associated with each digital emulated card, including for what type of access, service, or ticketing the digital emulated card is utilized. The type of access can include a particular apartment building, a particular facility, a particular employer, a particular transportation system in a particular region, or other factors. For example, the NFC device 102 can store data that indicates whether a particular card is a hotel room emulated card, an apartment emulated card, an employee emulated card, a train emulated card, a bus emulated card, etc.

The NFC device 102 can link each digital emulated card to one or more types of NFC reader 104. When the NFC device 102 is in the presence of an NFC reader 104, has analyzed the signals associated with the NFC reader 104 during polling, and has determined a type of the NFC reader 104, the NFC device 102 can then select the appropriate digital emulated card associated with or linked to that type of NFC reader 104. The NFC device 102 can then present the selected digital emulated card to the NFC reader 104.

In one embodiment, the NFC device 102 can periodically update the profile data associated with types of NFC readers 104. Update data can be received by the NFC device 102 from a remote system via the Internet or in another manner. The remote system may be associated with an organization that manages NFC functionality and the NFC device 102.

In one embodiment, an NFC reader 104 is associated with particular emulated cars (physical or emulated) to grant access or perform a service (e.g., receive a payment). When the NFC reader 104 grants access to or provides service to a particular digital emulated card presented by the NFC device 102, the NFC device 102 can store data indicating the type of the NFC reader 104 that granted access to the digital emulated card. When that type of NFC reader 104 is encountered again, the NFC device 102 may select that digital emulated card. In one embodiment, the data stored by the NFC device 102 can include an identification number of the NFC reader 104, a location of the NFC reader 104, a service provider associated with the NFC reader 104, or other types of data associated with the NFC reader 104. The technical effect of storing this data is to improve the speed and accuracy of card selection. This results in reduced delay, reduced power consumption, improved system efficiency in processing NFC transactions for large numbers of people, etc.

In one embodiment, it is possible that the NFC 102 device may not initially identify any emulated cards based on the characteristics of the polling of the NFC reader 104. In these cases, the NFC device 102 may successively present all of the emulated cards until an emulated card is accepted by the NFC reader 104. The NFC device 102 may then record data indicating the card that was accepted by the NFC reader 102. The NFC device 102 may utilize this information to selected emulated cards for NFC readers that have similar characteristics to the NFC reader that accepted the emulated card.

In one embodiment, the NFC device may build new NFC reader profiles or augment existing profiles based on the information learned from processes in which no emulated card is initially matched to an NFC reader. During an initial learning phase, the NFC device 102 may build up NFC reader profiles based on a plurality of such interactions with NFC readers 104. This may correspond to an initialization phase for emulated card matching.

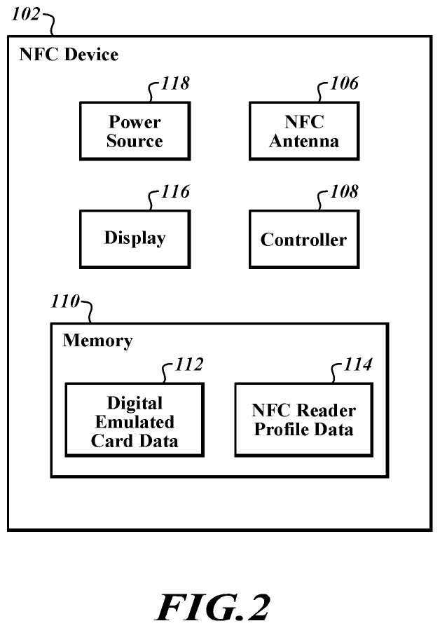

FIG. 2 is a block diagram of an NFC device 102, according to one embodiment. The NFC device 102 includes an NFC antenna 106, a controller 108, and a memory 110. As will be set forth in more detail below, the NFC antenna 106, the controller 108, and the memory 110 cooperate to effectively and efficiently select an appropriate digital emulated card to present to an NFC reader 104.

The NFC antenna 106 can include one or more antenna coils that facilitate NFC communication between the NFC device 102 and the NFC reader 104. The NFC antenna 106 may correspond to one or more radiofrequency antennas. In practice, the NFC antenna 106 may correspond to antenna of the NFC device 102 that facilitates radiofrequency communication of various types including NFC communication. The NFC antenna 106 can receive NFC signals from the NFC reader 104 and can output an NFC signals to the NFC reader 104.

The controller 108 controls the NFC antenna 106. The controller 108 may correspond to a microcontroller, a microprocessor, or another type of controller communicatively coupled to the NFC antenna 106. The controller 108 may include circuitry for processing and analyzing signals received by the NFC antenna 106. The controller 108 may extract data from signals received by the NFC antenna 106. The controller 108 may also control the NFC antenna 106 to output data to the NFC reader 104.

In one embodiment, the controller 108 is a dedicated NFC controller, or part of an NFC chip set. The dedicated NFC controller may be configured to control and communicate with other NFC circuitry of the NFC device 102 in order to facilitate NFC communication. Alternatively, the controller 108 may control various functions of the NFC device 102 in addition to NFC communication.

The NFC device 102 includes a memory 110. The memory 110 is coupled to the controller 108. Although FIG. 2 illustrates a single memory 110, in practice, the memory 110 may include multiple different memory arrays. The memory 110 may be external to the controller 108 or internal to the controller 108. A portion of the memory 110 may be embedded in the controller 108 while a portion of the memory 110 is external to the controller 108. The memory 110 can include one or more of read only memory (ROM), random access memory (RAM), static random access memory (SRAM), dynamic random access memory (DRAM), registers, buffers, electrically erasable and programmable read-only memory (EEPROM), flash memory, or other types of memory.

In one embodiment, the memory 110 includes digital emulated card data 112. The digital emulated card data 112 includes data associated with a plurality of digital emulated cards. The data associated with a digital emulated card can include an identification of the digital emulated card such as a unique identification (UID) or another type of identification. The data associated with a digital emulated card can include an organizational entity that issued the digital emulated card, the location or service for which the digital emulated card grants access, and issue date of the digital emulated card, an expiration date of the digital emulated card, data identifying one or more types of NFC readers 104 for which the digital emulated card has previously successfully granted access, location data associated with successful usages of the digital emulated card, links to one or more NFC reader profiles, or other types of data.

The memory 110 can include NFC reader profile data 114. The NFC reader profile data 114 can include profile data associated with a plurality of types of NFC readers 104. The profile data for a particular type of NFC reader 104 can include a carrier field type (always ON or ON/OFF), timing associated with the turning on or turning off of the carrier field, a type of interrogation signal, timings associated with the interrogation signal, the frequency associated with the carrier field, and a field strength associated with the carrier field. The profile data associated with the NFC reader type may include a manufacturer and model of the NFC reader type, locations, organizations, or services associated with the NFC reader type, or other types of data that can be associated with a type of an NFC reader 104. The memory 110 may store other data including software instructions and other types of data utilized by the controller 108 in performing NFC communication.

The NFC device 102 may include a display 116. The display 116 can include one or more of a screen, indicator LEDs, or other types of displays that can present information to a user of the NFC device 102. The display 116 may display information of all of the emulated cards stored in the memory of the NFC device 102. The display 116 may display information of the emulated card presented to the NFC reader 104. The display 116 may display information of the selected emulated card.

The NFC device 102 may include a power source 118. The power source 118 can include one or more batteries. The power source 118 can include connections that enable power to be received from an external power source. The power source 118 can include circuitry for harvesting energy from wireless signals received from external sources.

In one embodiment, when a user of the NFC device 102 desires to gain access to a location or service by providing emulated card data to an NFC reader 104, the user of the NFC device 102 positions the NFC device 102 near the NFC reader 104. The NFC reader 104 is, by default, in a polling mode. In the polling mode, the NFC reader 104 outputs a carrier field as described previously. The NFC reader 104 periodically outputs an interrogation signal by modulating the carrier field. The NFC device 102 detects the carrier field from the NFC reader 104.

When the NFC device 102 detects the carrier field and the interrogation signal of the NFC reader 104, the NFC device 102 does not respond to the interrogation signal. Instead, the NFC device 102 enters a silent monitoring phase for a selected duration of time or for a selected number of interrogation signals. In one embodiment, during the silent monitoring phase, the NFC device 102 records the characteristics of either or both of the carrier field and the interrogation signal without providing any response to the NFC reader 104. In particular, the controller 108 analyzes the signals received by the NFC antenna 106 and records the characteristics of the signals received by the antenna 106. As used herein, “silent monitoring” does not refer to the lack of audible sound, but to the lack of any NFC response signal from the NFC device 102 upon receiving carrier field and/or interrogation signal from the NFC reader 104.

After the silent monitoring phase, the controller 108 may analyze the characteristics of the carrier field and the interrogation signals. In particular, the controller 108 may compare the characteristics of the carrier field and interrogation signals to the profiles in the NFC reader profile data 114. The controller 108 may identify an NFC reader profile that most closely aligns with the recorded characteristics of either or both of the carrier and interrogation signals received from the NFC reader 104. The controller 108 may match the signals to one of the profiles in the NFC reader profile data 114. The analysis and matching may also happen in a control system other than the controller 108. In one embodiment, the controller 108 may be replaced by another control system. In one embodiment, the NFC device 102 may have multiple controllers and control systems. The analysis and matching may be performed by other types of control systems without departing from the scope of the present disclosure.

After the controller 108 matches the signals to one of the profiles from the NFC reader profile data 114, the controller 108 selects a digital emulated card from the plurality of digital emulated card to the digital emulated card data 112. In particular, the controller 108 identifies a digital emulated card that may be associated or that was previously associated with the selected NFC reader profile. This can include identifying a card that has previously been utilized successfully with that type of NFC reader 104, identifying a card whose issuing organization or type of function is associated with the identified NFC reader type, or that in some other way can be associated with the NFC reader type.

In one embodiment, after the controller 108 has selected an emulated card, the controller 108 controls the NFC antenna 106 to establish NFC communication with the NFC reader 104 in response to a subsequent interrogation signal from the NFC reader 104. In particular, the NFC device 102 may provide identification data or other types of data to the NFC reader 104 via NFC in order to establish NFC communication with the NFC reader 104. The controller 108 may provide data from the selected digital emulated card to the NFC reader 104 via NFC. This may result in the NFC reader 104 accepting the digital emulated card in granting the user access to the service or location associated with the NFC reader 104.

In some cases, it is possible that the initially selected digital emulated card may be rejected by the NFC reader 104. In this case, the NFC device 102 may present a next most likely digital emulated card based on the identified NFC reader profile. Accordingly, rather than presenting digital emulated cards in a random manner or in a preset order, the NFC device 102 can present digital emulated cards in an order based on characteristics of the NFC reader profile and the characteristics or associations of the digital emulated cards.

In some cases, the analysis and matching may identify multiple emulated cards that may be compatible with an NFC reader 104. Accordingly, the NFC device 102 may select multiple compatible emulated cards to present to the NFC reader 104. The NFC reader 102 may then present each of the selected cards successively until the correct card is presented to the NFC reader 104. As set forth previously, the correct card may correspond to the emulated card for which the NFC reader 104 grants access or service. Once the correct card is identified, the NFC device 102 may then complete the information relating to the emulated card, with additional information from the NFC reader. Such additional information may include a reader identification, location, or other characteristics.

FIG. 3 includes graphs 302 and 304 of carrier fields output by NFC readers 104, in accordance with one embodiment. The graph 302 illustrates a carrier field that is periodically turned off. Accordingly, the carrier field of the graph 302 may be described as an ON/OFF carrier field. An NFC device 102 is brought into proximity with an NFC reader 104. The NFC device is initially in a silent monitoring phase. At time T0, the carrier field turns on. The carrier field has an amplitude A, and corresponds to a radiofrequency field. At time T1, the NFC reader 104 generates an interrogation signal by modulating the carrier field. The NFC device records the duration between T0 and T1.

The interrogation signal may be relatively short. FIG. 3 illustrates the interrogation signal is a single moment in time T1. However, in practice, the interrogation signal has a duration that is recorded by the NFC device 104. At time T2, the carrier field turns off. The NFC device 102 records the time between the end of the interrogation signal and T2. The NFC device also records the total elapsed time between the T0 and T2. The carrier field turns on at time T3. The NFC device records the duration that the carrier field is off between times T2 and T3. At time T4, the interrogation signal is output again. At time T5, the carrier field turns off again. At time T6, the carrier field turns on again. At time T7, the interrogation signal is output again. At time T8, the carrier field turns off again. The NFC device 102 records all the timing characteristics of the polling phase of the NFC reader 104. In practice, the carrier field may be on for variable lengths of time and may be off for variable lengths of time. Furthermore, the interrogation signal may be output at different times after the carrier field is turned back on.

The silent monitoring phase may last for a fixed duration, or for a fixed number of polling cycles. In one embodiment, the monitoring phase has a duration between 25 ms and 200 ms. In one embodiment, the monitoring phase lasts between 10 and 50 interrogation cycles. Other durations can be utilized for the silent monitoring phase without departing from the scope of the present disclosure.

During the silent monitoring phase, the NFC device 102 measures the frequency of the carrier field. As described previously, NFC standards may define the carrier field should have a frequency of 13.56 MHz. However, in practice, manufacturers may produce NFC readers 104 that have frequencies that are not centered on 13.56 MHz. The NFC device 102 measures these frequencies.

During the silent monitoring phase, the NFC device 102 measures the amplitude of the carrier field. Because the NFC device 102 may be moving relative to the NFC reader 104, the measured amplitude may change of time. Nevertheless, the measured amplitude can be beneficial in determining the type of the NFC reader 104 if the measured amplitude is higher, then the maximum measured amplitude of most NFC readers 104.

The interrogation signal can be one of various types of interrogation signals. The interrogation signal can be type A, type B, type F, type V, or other types. Each of these types may be defined by standards and may have characteristic durations, features, formats, or other types of timing and signaling features. For example, NFC type A signaling may be defined, in part, by the ISO/IEC 14443A standard. NFC type B signaling may be defined, in part, by the ISO/IEC 14443B standard. NFC type F signaling may be defined, in part, by the standard FeliCA JIS X6319-4 standard. NFC type V signaling may be defined, in part, by the ISO/IEC 15693 standard. It is noted that standards and timings may change from time to time. The NFC device 102 records the type of each interrogation signal. The NFC device 102 may also records again with which each interrogation signal is received.

The graph 304 illustrates a carrier signal that is always on during polling. At time T0, the NFC device 102 detects the carrier signal. At time T1, the NFC device 102 detects an interrogation signal. As described previously, the NFC device 102 may record the duration of the interrogation signal, the type of the interrogation signal, or other features associated with the interrogation signal. At time T2, the interrogation signal is again output. The NFC device 102 records the elapsed time between interrogation signals. The NFC device 102 detects interrogation signals at times T3, T4, T5, T6, T7, and T8. The NFC device 102 records the characteristics of each of the interrogation signals and the timings associated with the interrogation signals. The NFC device 102 records the various types of information during the silent polling phase so that the NFC device 102 can determine a type of the NFC reader 104 and can select an appropriate digital emulated card to present to the NFC reader 104.

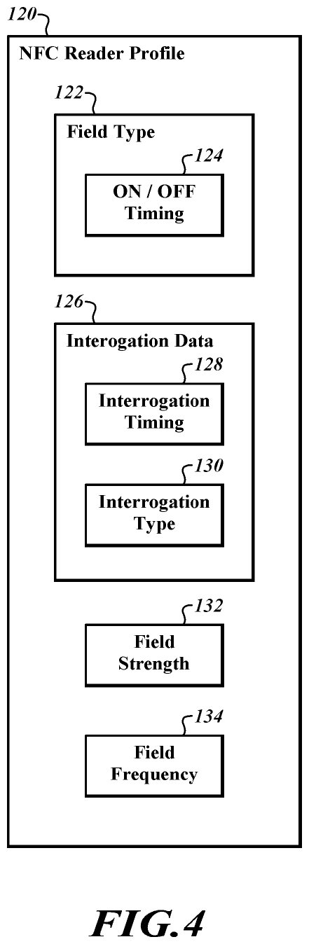

FIG. 4 is a block diagram of an example of a reader profile 120 stored in the memory 110 of an NFC device 102, according to one embodiment. The NFC reader profile 120 includes a field type 122 of the carrier field. The field type 122 can indicate whether the carrier field is an ON type or an ON/OFF. The NFC reader profile 120 can also include timing data 124 associated with ON/OFF type carrier fields. This can include the ON duration and the duration of the carrier field.

The NFC reader profile 120 can include interrogation data 126. The interrogation data 126 includes data related to the interrogation signals output by an NFC reader. The interrogation data can include interrogation timing 128. The interrogation timing 128 indicates the duration of an interrogation signal, the time between the turning on of the carrier field and the beginning of the interrogation signal, and the time between the end of the interrogation signal and the turning off time of the third field. The interrogation data 126 can also include interrogation type 130, indicating the type of the interrogation signal (e.g. type A, type B, etc.). The interrogation data 126 can include other data related to characteristics of the interrogation signal.

The NFC reader profile data 120 includes field strength data 132. The field strength data 132 can include the amplitude associated with the carrier field. The measurement of the carrier field will depend, in part, on the proximity of the NFC device 102 to the NFC reader 104. Nevertheless, some NFC readers may have a carrier field amplitude that is higher than other readers. If the measured amplitude of a carrier field is abnormally high, this can be an indication of the type of reader.

The NFC reader profile 120 can include a field frequency data 134. This can correspond to the central frequency of the carrier field. As described previously, some NFC readers 104 may output carrier fields with central frequencies that diverge from the standard 13.56 MHz by some characteristic amount. Accordingly, the central frequency of the carrier field can help in identifying the type of the NFC reader.

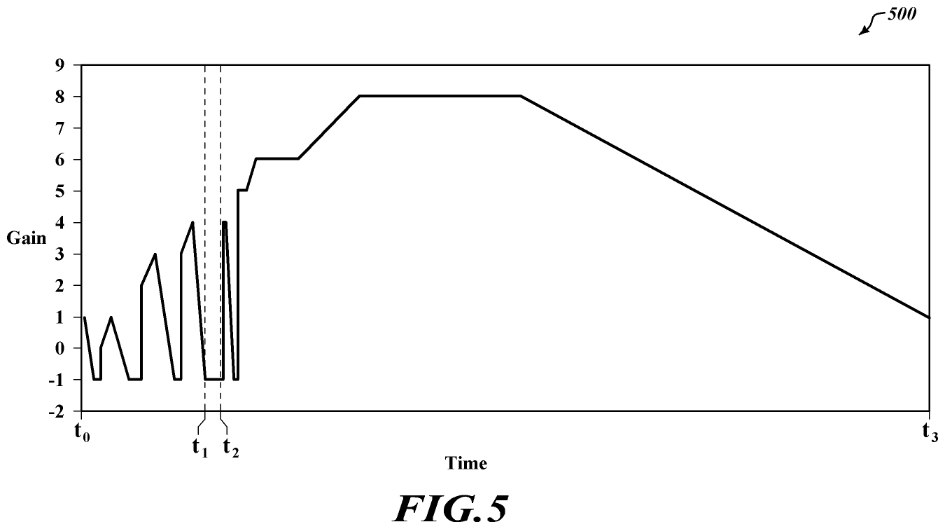

FIG. 5 is a graph 500 of a carrier field output by an NFC reader 104, in accordance with one embodiment. The y-axis the case the gain or amplitude with which the carrier signal is received. The x-axis time. At time T0, and NFC device 102 detects the carrier field of an NFC reader 104. Between times T0 and T1, the NFC device 102 is in a silent monitoring phase and detects several cycles of interrogation signals in the carrier signal. Between times T1 and T2, the NFC device selects a digital emulated card based on comparison of the characteristics of the carrier field with the NFC reader profile data 120. At time T2, the NFC device 102 responds to the NFC reader 104. Between times T2 and T3, the NFC device 102 communicates with the NFC reader 104. This can include presenting the digital emulated card data of the selected digital emulated card to the NFC reader 104.

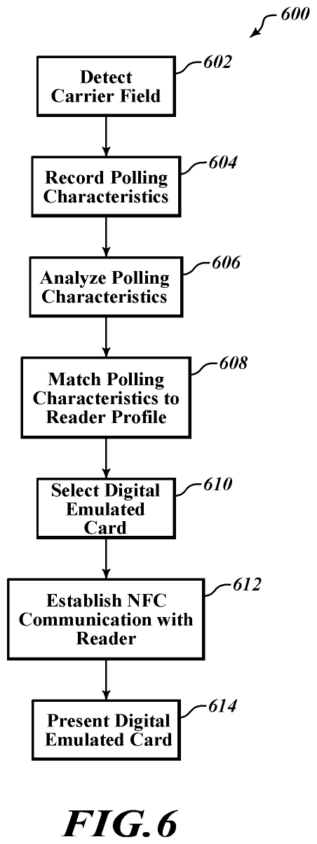

FIG. 6 is a flow diagram of a process 600 for performing NFC communication, according to one embodiment. At 602, an NFC device detects the carrier field of an NFC reader. At 604, the NFC device records polling characteristics of the NFC reader 104. This can include recording timing, amplitude, frequency, and other characteristics of the carrier field and interrogation signals. At 606, the NFC device analyzes the polling characteristics. At 608, the NFC device matches the polling characteristics to a reader profile. At 610, the NFC device selects a digital emulated card based on the matched profile. At 612, the NFC device 102 establishes NFC communication with the NFC reader. At 614, the NFC device presents the digital emulated card to the NFC reader via NFC communication. In one embodiment, at 610 the NFC device may select multiple emulated cards that are compatible with the reader profile. At 614, the NFC device may successively present the set of emulated cards until an emulated card is accepted by the NFC reader.

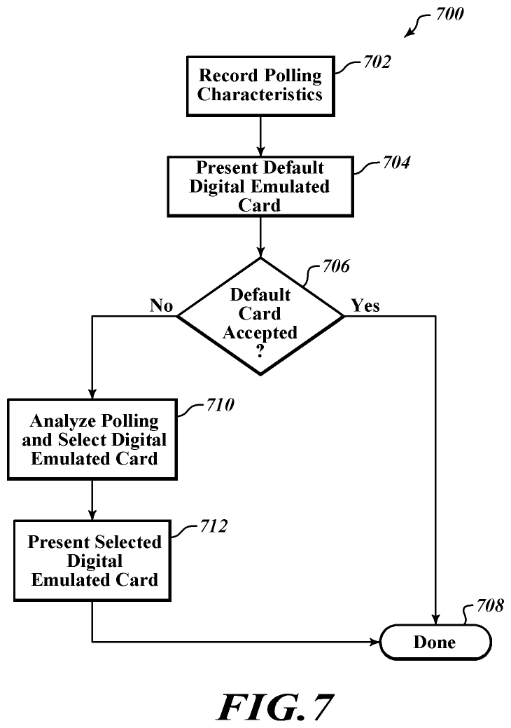

FIG. 7 is a flow diagram of a process 700 for performing NFC communication, according to one embodiment. At 702, and NFC device records polling characteristics of an NFC reader. At 704, the NFC device presents a default digital emulated card to the NFC reader. At 706, the NFC device 102 detects whether or not the default card has been accepted. If the default card has been accepted, then at 708 the process 700 is complete. If the default card has not been accepted, then at 710 the NFC device analyzes the polling characteristics and selects a digital emulated card based on the polling characteristics. At 712, the NFC device presents the selected digital emulated card. At 708, the process ends.

The process 700 can be beneficial in that the NFC device has a default card that will be presented regardless of the polling characteristics. Nevertheless, before presenting the default digital emulated card, the NFC device records the polling characteristics without responding to the NFC reader, as described previously. This is beneficial because if the default card is not accepted, then the NFC device already has the polling characteristics and does not need to wait for the NFC reader to reset to a polling mode in order to record polling characteristics after rejection of a default digital emulated card. Instead, the NFC device can analyze the polling data and select an emulated card based on the point data as described previously. The NFC device can present the selected digital emulated card to the NFC reader.

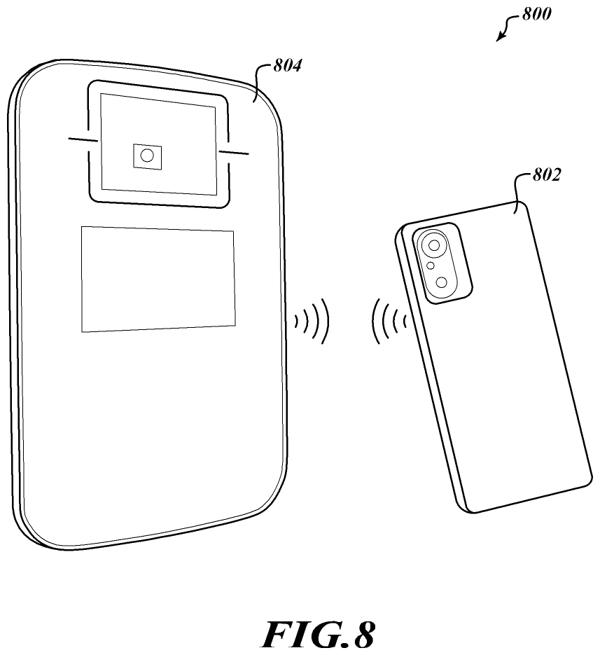

FIG. 8 is an illustration of an NFC system 800, in accordance with one embodiment. The NFC system 800 is one example of an NFC system 100 of FIG. 1. The NFC system 800 includes a mobile phone 802 and a mounted NFC reader 804. The NFC reader 804 is one example of an NFC reader 104 of FIG. 1. The mobile phone 802 is one example of an NFC device 102 of FIG. 1.

In the example of FIG. 8, the mobile phone 802 stores a plurality of digital emulated cards and includes NFC reader profiles. The user of the mobile phone 802 positions the mobile phone 802 adjacent to the NFC reader 804. The mobile phone 802 detects the carrier field of the NFC reader 804 and enters a silent monitoring phase in which the mobile phone 802 records the characteristics of the polling phase of the NFC reader 804. The mobile phone 802 can then analyze the characteristics of the polling phase and can match the NFC reader 804 to an NFC reader profile. The mobile phone 802 can then select a digital emulated card to be presented to the NFC reader 804 based on the polling characteristics. The NFC reader can then present the digital emulated card data to the NFC reader 804 via NFC communication.

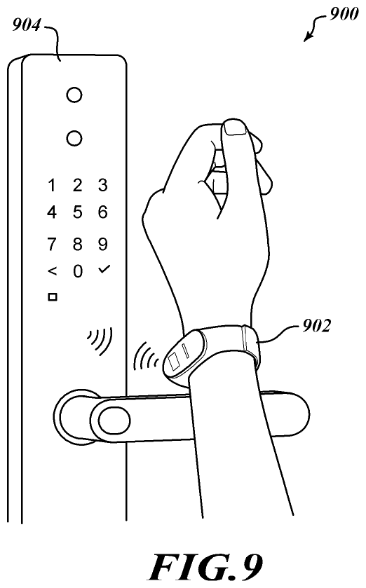

FIG. 9 is an illustration of an NFC system 900, in accordance with one embodiment. The NFC system 900 is one example of an NFC system 100 of FIG. 1. The NFC system 900 includes a smart watch 902 and a mounted NFC reader 904. The NFC reader 904 is one example of an NFC reader 104 of FIG. 1. The smart watch 902 is one example of an NFC device 102 of FIG. 1.

In the example of FIG. 9, the smart watch 902 stores a plurality of digital emulated cards and includes NFC reader profiles. The user of the smartwatch 902 positions the smartwatch 902 adjacent to the NFC reader 904. The smartwatch 902 detects the carrier field of the NFC reader 904 and enters a silent monitoring phase in which the smartwatch 902 records the characteristics of the polling phase of the NFC reader 904. The smartwatch 902 can then analyze the characteristics of the polling phase and can match the NFC reader 904 to an NFC reader profile. The smartwatch 902 can then select a digital emulated card to be presented to the NFC reader 904 based on the polling characteristics. The smartwatch 902 can then present the digital emulated card data to the NFC reader 904 via NFC communication.

Other types of electronic devices aside from mobile phones and smart watches can be utilized for an NFC device 102 without departing from the scope of the present disclosure. Furthermore, other types of NFC readers can be utilized without departing from the scope of the present disclosure. For example, a mobile phone may act as an NFC reader in one embodiment. The polling characteristics can indicate that the NFC reader is a smart phone, and may indicate a type of smart phone.

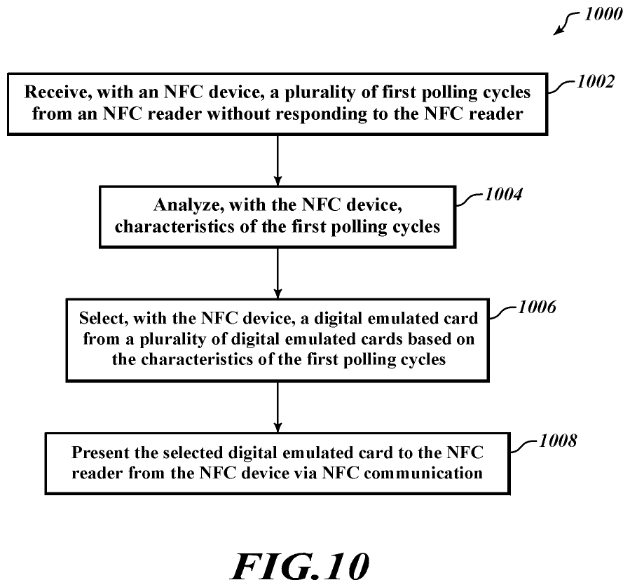

FIG. 10 is a flow diagram of a method 1000 for operating an NFC system, according to one embodiment. The method 1000 can utilize the systems, processes, devices, and components described in relation to FIGS. 1-9. At 1002, the method 1000 includes receiving, with an NFC device, a plurality of first polling cycles from an NFC reader without responding to the NFC reader. At 1004, the method 1000 includes analyzing, with the NFC device, characteristics of the first polling cycles. At 1006, the method 1000 includes selecting, with the NFC device, a digital emulated card from a plurality of digital emulated cards based on the characteristics of the first polling cycles. At 1008, the method 1000 includes presenting the selected digital emulated card to the NFC reader from the NFC device via NFC communication.

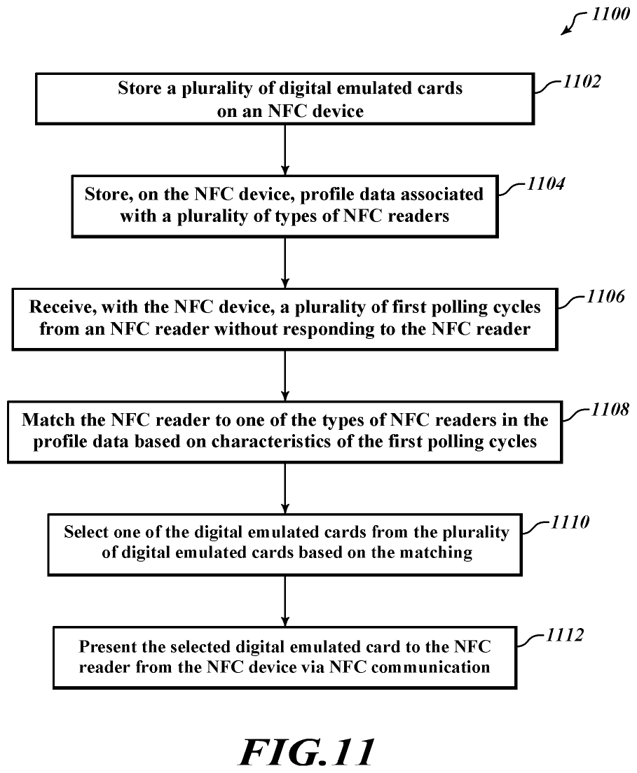

FIG. 11 is a flow diagram of a method 1100 for operating an NFC system, according to one embodiment. The method 1100 can utilize the systems, processes, devices, and components described in relation to FIGS. 1-10. At 1102, the method 1100 includes storing a plurality of digital emulated cards on an NFC device. At 1104, the method 1100 includes storing, on the NFC device, profile data associated with a plurality of types of NFC readers. At 1106, the method 1100 includes receiving, with the NFC device, a plurality of first polling cycles from an NFC reader without responding to the NFC reader. At 1108, the method 1100 includes matching the NFC reader to one of the types of NFC readers in the profile data based on characteristics of the first polling cycles. At 1110, the method 1100 includes selecting one of the digital emulated cards from the plurality of digital emulated cards based on the matching. At 1112, the method 1100 includes presenting the selected digital emulated card to the NFC reader from the NFC device via NFC communication.

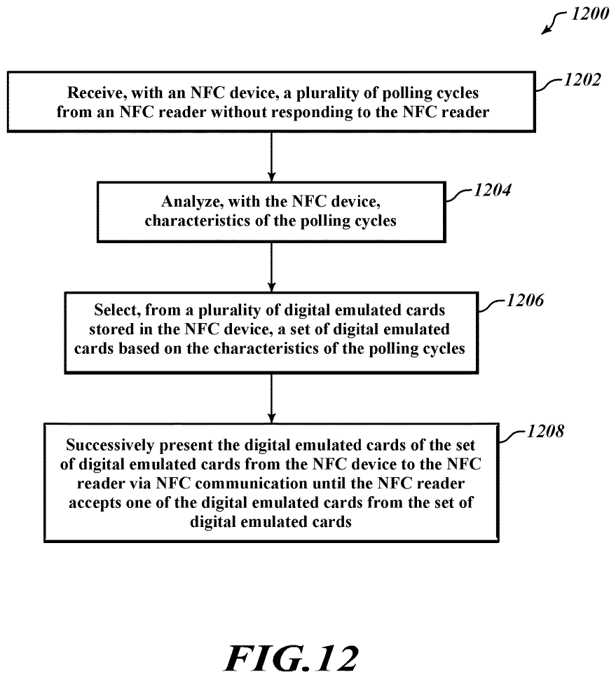

FIG. 12 is a flow diagram of a method 1200 for operating an NFC system, according to one embodiment. At 1202, the method 1200 includes receiving, with an NFC device, a plurality of polling cycles from an NFC reader without responding to the NFC reader. At 1204, the method 1200 includes analyzing, with the NFC device, characteristics of the polling cycles. At 1206, the method 1200 includes selecting, from a plurality of digital emulated cards stored in the NFC device, a set of digital emulated cards based on the characteristics of the polling cycles. At 1208, the method 1200 includes successively presenting the digital emulated cards of the set of digital emulated cards from the NFC device to the NFC reader via NFC communication until the NFC reader accepts one of the digital emulated cards from the set of digital emulated cards.

In one embodiment, a method includes receiving, with an NFC device, a plurality of first polling cycles from an NFC reader without responding to the NFC reader and analyzing, with the NFC device, characteristics of the first polling cycles. The method includes selecting, with the NFC device, a digital emulated card from a plurality of digital emulated cards based on the characteristics of the first polling cycles and presenting the selected digital emulated card to the NFC reader from the NFC device via NFC communication.

In one embodiment, a method includes storing a plurality of digital emulated cards in an NFC device, storing, in the NFC device, profile data associated with a plurality of types of NFC readers, and receiving, with the NFC device, a plurality of first polling cycles from an NFC reader without responding to the NFC reader. The method includes matching the NFC reader to one of the types of NFC readers in the profile data based on characteristics of the first polling cycles, selecting one of the digital emulated cards from the plurality of digital emulated cards based on the matching, and presenting the selected digital emulated card to the NFC reader from the NFC device via NFC communication.

In one embodiment, an NFC device includes an NFC antenna and a memory configured to store digital emulated card data of a plurality of digital emulated cards the NFC device includes a controller coupled to the memory and the NFC antenna and configured to implement a silent monitoring phase responsive to the NFC antenna receiving a carrier field from an NFC reader.

In one embodiment, a method includes storing a plurality of digital emulated cards in an NFC device, storing, in the NFC device, profile data associated with a plurality of types of NFC readers, and receiving, with the NFC device, a plurality of first polling cycles from an NFC reader without responding to the NFC reader. The method includes recording, with the NFC device, characteristics of the first polling cycles, receiving a second polling cycle from the NFC reader, and presenting, from the plurality of digital emulated cards, a default digital emulated card to the NFC device after receiving the second polling cycle.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, with an NFC device, a plurality of first polling cycles from an NFC reader without responding to the NFC reader;
analyzing, with the NFC device, characteristics of the first polling cycles;
selecting, with the NFC device, a digital emulated card from a plurality of digital emulated cards based on the characteristics of the first polling cycles; and
presenting the selected digital emulated card to the NFC reader from the NFC device via NFC communication.

2. The method of claim 1, wherein each polling cycle includes receiving an interrogation signal in a carrier field.

3. The method of claim 2, wherein analyzing the characteristics includes determining whether the carrier field is an ON/OFF type carrier field, wherein analyzing the characteristics includes determining a duration of the ON state of the carrier field, determining a duration of the OFF state of the carrier field, and determining a timing of the interrogation signals within the carrier field.

4-5. (canceled)

6. The method of claim 2, wherein analyzing the characteristics includes determining a central frequency of the carrier field.

7. The method of claim 2, wherein analyzing the characteristics includes determining an amplitude of the carrier field.

8. The method of claim 2, comprising:
storing, in the NFC device, NFC reader profile data including profiles for each of a plurality of NFC reader types, wherein analyzing the characteristics of the first polling cycles includes comparing the characteristics of the first polling cycles to the reader profile data;
identifying a type of the NFC reader by matching the characteristics of the first polling cycles to one of the NFC reader types; and
selecting the digital emulated card based on the characteristics of the first polling cycles.

9-13.

14. The method of claim 1, comprising:
receiving, after selecting the digital emulated card, a second polling cycle from the NFC reader; and
presenting the digital emulated card after receiving the second polling cycle.

15. The method of claim 1, wherein selecting a digital emulated card from a plurality of digital emulated cards based on the characteristics of the first polling cycles includes selecting a set of digital emulated cards from the plurality of digital emulated cards, wherein presenting the selected digital emulated card to the NFC reader includes successively presenting the digital emulated cards of the set of digital emulated cards, the method comprising, if one of the digital emulated cards is accepted by the NFC reader, augmenting stored information related to the accepted digital emulated with information related to the NFC reader.

16. (canceled)

17. The method of claim 1, comprising, if the digital emulated cards is accepted by the NFC reader, augmenting stored information related to the accepted digital emulated with information related to the NFC reader.

18. A method, comprising:
storing a plurality of digital emulated cards in an NFC device;
storing, in the NFC device, profile data associated with a plurality of types of NFC readers;
receiving, with the NFC device, a plurality of first polling cycles from an NFC reader without responding to the NFC reader;
matching the NFC reader to one of the types of NFC readers in the profile data based on characteristics of the first polling cycles;
selecting one of the digital emulated cards from the plurality of digital emulated cards based on the matching; and
presenting the selected digital emulated card to the NFC reader from the NFC device via NFC communication.

19. The method of claim 18, wherein the profile data indicates one or more of:
locations in which an NFC reader type is utilized;
services for which an NFC reader type is utilized; and
companies by which an NFC reader type is utilized;
a manufacturer of an NFC reader type; and
a model of an NFC reader.

20-21. (canceled)

22. The method of claim 18, wherein:
selecting one of the digital emulated cards includes selecting a set of digital emulated cards from the plurality of digital emulated cards;
presenting the selected digital emulated card includes successively presenting the digital emulated cards of the set of digital emulated cards.

23. The method of claim 22 comprising, if one of the digital emulated cards is accepted, augmenting stored information related to the accepted digital emulated with information related to the NFC reader.

24. An NFC device, comprising:
an NFC antenna;
a memory configured to store digital emulated card data of a plurality of digital emulated cards; and
a controller coupled to the memory and the NFC antenna and configured to implement a silent monitoring phase responsive to the NFC antenna receiving a carrier field from an NFC reader.

25. The NFC reader of claim 24, wherein the controller is configured to record, during the silent monitoring phase, characteristics of a plurality of polling cycles received by the NFC antenna from the NFC reader.

26. The NFC reader of claim 25, wherein the controller is configured to identify a type of the NFC reader based on the characteristics of the polling cycles and to select one of the digital emulated cards based on the type of the NFC reader.

27. The NFC reader of claim 25, wherein the controller is configured to present the selected digital emulated card to the NFC reader via NFC communication.

28. The NFC reader of claim 25, wherein the memory is configured to store NFC reader profile data including profiles for each of a plurality of NFC reader types.

29. The NFC reader of claim 28, wherein the analyzing the characteristics of the polling cycles includes comparing the characteristics of the polling cycles to the reader profile data.

30. The NFC reader of claim 29, wherein the controller is configured to identify the type of the NFC reader by matching the characteristics of the polling cycles to one of the NFC reader types.

31-36. (canceled)
